(19) United States
(12) Patent Application Publication
(10) Pub. No.: US 2007/0274562 A1
(43) Pub. Date: Nov. 29, 2007

(54) Image processing apparatus, image processing method and recording medium

(75) Inventor: Haruna Sasakuma, Toyonaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/797,326

(22) Filed: May 2, 2007

(30) Foreign Application Priority Data
May 25, 2006 (JP) 2006-146011

(51) Int. Cl. G06K 9/00

(52) U.S. Cl. 382/100

(57) ABSTRACT

An image processing apparatus comprises a document data specification unit to specify document data to be merged, among document data accumulated in an accumulation unit; a scanner unit to read a document; and a control unit to merge image data of the document read by said scanner unit with said specified document data and then replace the original document data with the merged data, or alternatively, to give instructions for the merger and the replacement.

This application claims priority under 35 U.S.C. §119 to Japanese Patent Application No. 2006-146011 filed on May 25, 2006, the entire disclosure of which is incorporated herein by reference in its entirety.

### BACKGROUND OF THE INVENTION

1. Field of the Invention

The present invention relates to an image processing apparatus that is applied to an image forming apparatus such as a MFP (Multi Function Peripheral), an image processing method in the image processing apparatus, and an image processing program to make a computer in the image processing apparatus execute image processing.

2. Description of the Related Art

The following description sets forth the inventor's knowledge of related art and problems therein and should not be construed as an admission of knowledge in the prior art.

With the development of networks, it has now become prevalent, for instance, to create a shared folder for a group in a user terminal on a network, accumulate document data in the folder, and share the document data with a plurality of members of the group.

In this regard, a user sometimes would like not only to merge original document data already recorded in the shared holder with image data of a document read by a scanner unit in an image forming apparatus such as a MFP, etc. but also to replace the original document data with the merged data, with the intention to add new related information to the original data. Otherwise, a user sometimes would like to replace the original document data with image data of a document ready by the scanner unit.

In the former case, the user conventionally had to first read a document and convert it to image data by the scanner unit in the MFP, etc., then merge the image data to the original document data using dedicated application software installed on the user terminal, and then replace the original document data with the merged data.

In the case where a user would like to replace the original document data with image data of a document read by the scanner unit, the user conventionally had to separately perform the operations: reading a document and converting it to image data by the scanner unit in the MFP, etc., and replacing the original document data with the image data.

However, in these cases, the user is required to perform a number of operations to complete the process, which is a bother and troublesome. Besides, dedicated application software is also needed to merge the readout image data with the document data, and it is also a bother to learn how to operate the software.

According to an art to merge two pieces of data, which is disclosed in Japanese Laid-open Patent Publication No. 2005-176008, readout image data and image data recorded in a shared folder in a user terminal are merged and transmitted to a specified destination by facsimile.

Meanwhile, according to an art heretofore known, in a MFP, image data of a document read by a scanner unit is preliminarily stored in a box as an electronic document, and the electronic document is merged with another electronic document also stored in the box when needed.

However, none of the conventional arts mentioned above is the one to merge two pieces of data and replace original document data with the merged data, neither the one to replace original document data with image data of a document read by a scanner unit. Thus, a specific operation is anyway needed to replace original document data with merged data or image data read out by a scanner unit, which is still a bother and troublesome.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

A first object of the present invention is to provide an image processing apparatus that is able not only to merge image data read out by a scanner unit with document data, but also to replace automatically the original document data with the merged data, by simple operation.

A second object of the present invention is to provide an image processing method that is able to merge image data read out by a scanner unit with document data, but also to replace automatically the original document data with the merged data, by simple operation.

A third object of the present invention is to provide a recording medium having a recorded image processing program to make a computer in the image processing apparatus execute image processing.

A fourth object of the present invention is to provide an image processing apparatus that is able to replace automatically original document data with image data read out by a scanner unit by simple operation.

A fifth object of the present invention is to provide an image processing method that is able to replace automatically original document data with image data read out by a scanner unit by simple operation.

A sixth object of the present invention is to provide a recording medium having a recorded imaging processing program to make a computer in the image processing apparatus execute image processing.

According to a first aspect of the present invention is an image processing apparatus, comprising:
a document data specification unit to specify document data to be merged, among document data accumulated in an accumulation unit;
a scanner unit to read a document; and
a control unit to merge image data of the document read by said scanner unit with said specified document data and then replace the original document data with the merged data, or alternatively, to give instructions for the merger and the replacement.

According to a second aspect of the present invention is an image processing apparatus, comprising:
a document data specification unit to specify document data to be replaced, among document data accumulated in an accumulation unit;
a scanner unit to read a document; and
a control unit to control a process to replace said specified document data with image data read out by said scanner unit, or alternatively, to give an instruction for the replacement.

According to a third aspect of the present invention is an image processing method that is used in an image processing apparatus, and the image processing method comprises:
specifying document data to be merged, among document data accumulated in an accumulation unit;
reading a document by a scanner unit; and
controlling a process to merge image data of the document read by said scanner unit with said specified document data and then replace the original document data with the merged data, or alternatively, give instructions for the merger and the replacement.

According to a fourth aspect of the present invention is an image processing method that is used in an image processing apparatus, and the image processing method comprises:
specifying document data to be replaced, among document data accumulated in an accumulation unit;
reading a document by a scanner unit; and
replacing said specified document data with image data of the document read by said scanner unit, or alternatively, giving an instruction for the replacement.

According to a fifth aspect of the present invention is a recording medium, having a recorded image processing program to make a computer in an image processing apparatus execute:
specifying document data to be merged, among document data accumulated in an accumulation unit;
reading a document by a scanner unit; and
merging image data of the document read by said scanner unit with said specified document data and then replacing the original document data with the merged data, or alternatively, giving instructions for the merger and the replacement.

According to a sixth aspect of the present invention is a recording medium, having a recorded image processing program to make a computer in an image processing apparatus execute:
specifying document data to be replaced, among document data accumulated in an accumulation unit;
reading a document by a scanner unit; and
replacing said specified document data with the image data of the document read by said scanner unit, or alternatively, giving an instruction for the replacement.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a conceptual diagram of an image processing system, in which an image processing apparatus according to one embodiment of the present invention is used;

FIG. 2 is a block diagram showing an electrical configuration of a user terminal that is used in the system shown in FIG. 1;

FIG. 3 is a block diagram showing an electrical configuration of a MFP that is used in the system shown in FIG. 1;

FIG. 4 is a function setting screen that is displayed in a display unit of an operation panel unit;

FIG. 5 is a destination setting screen that is displayed in a display unit of an operation panel unit;

FIG. 6 is a flowchart showing an example of a merger and replacement process, which is started by pressing a “scan” button;

FIG. 7 is a diagram showing a scan setting table;

FIG. 8 is an attribute setting screen that is displayed in a display unit of an operation panel unit;

FIG. 9 is a flowchart showing another example of a merger and replacement process, which is started by pressing a “scan” button;

FIG. 10 is a destination setting screen that is displayed in a display unit of an operation panel unit if document data has more than one page;

FIG. 11 is a flowchart showing yet another example of a merger and replacement process, which is started by pressing a “scan” button;

FIG. 12 is a destination setting screen that is displayed in a display unit of an operation panel unit when document data is replaced with readout image data; and

FIG. 13 is a flowchart showing an example of a replacement process, which is started by pressing a “scan” button.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

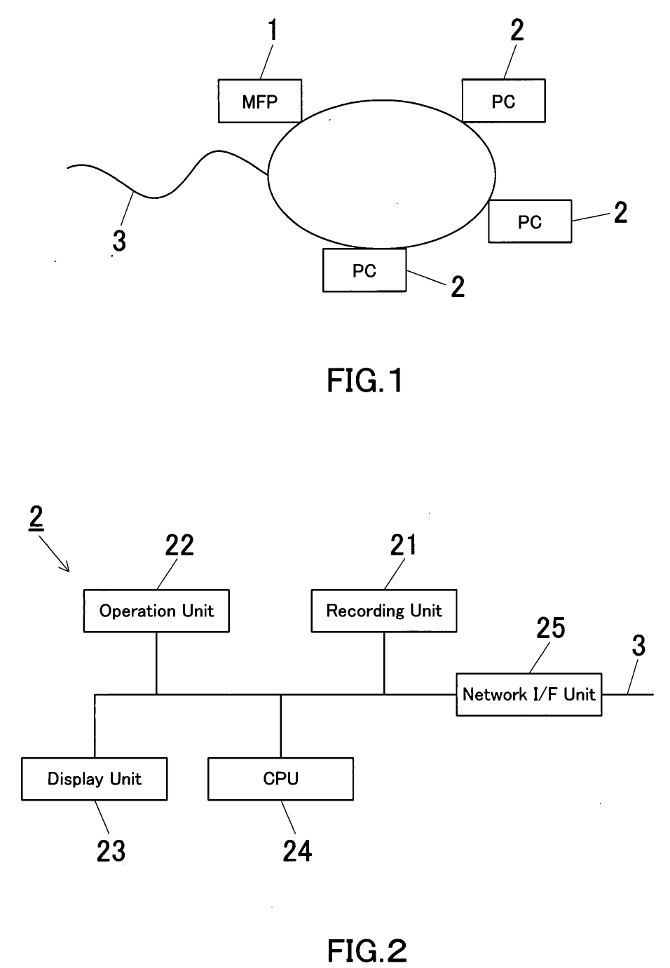

FIG. 1 is a conceptual diagram showing an image processing system, in which an image processing apparatus according to one embodiment of the present invention is used.

As shown in FIG. 1, the image processing system comprises a MFP 1 that is a multifunctional digital image forming apparatus having functions such as copying, printing, scanning, and facsimile, and personal computers (hereinafter referred to as “PCs”) 2 as user terminals, wherein the MFP 1 and the PCs 2 are connected via a network 3.

FIG. 2 is a block diagram showing an electrical configuration of a PC 2.

As shown in FIG. 2, the PC 2 comprises a recording unit 21 as an accumulation unit, an operation unit 22, a display unit 23, a CPU 24, and a network interface (I/F) unit 25.

The recording unit 21 comprises a hard disk drive (HDD), and it stores folders, files, installed application software, etc. in itself.

An attribute, “share” can be given to a folder, and document data in folders having the “share” attribute (shared folders) can be accessed and operated from other PCs 2 that are connected to the same network 3.

The operation unit 22 comprises a keyboard, a mouse, etc., and it is used for various instruction inputs, mode selections, and other operations.

The display unit 23 comprises a liquid crystal display for instance, and it displays various data.

The CPU 24 serves to control the overall PC 2.

The network I/F unit 25 has a communication function to exchange data with other PCs 2 and the MFP 1, via the network 3.

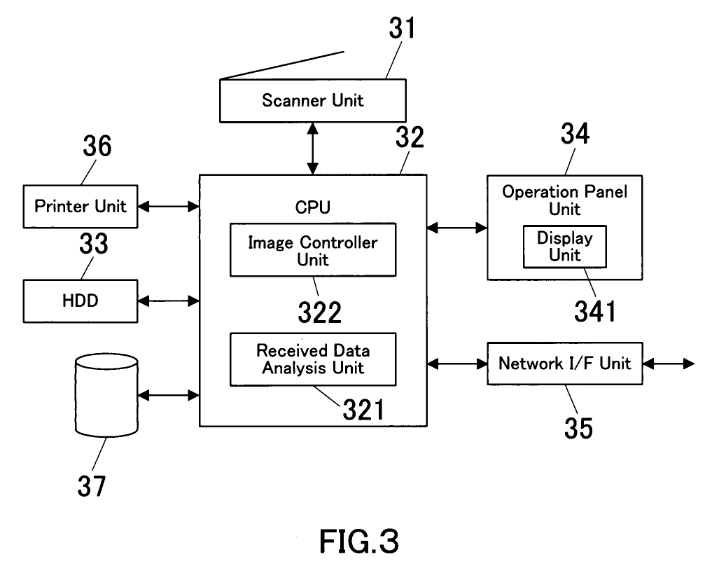

FIG. 3 is a block diagram showing an electrical configuration of the MFP 1.

As shown in FIG. 3, the MFP 1 comprises a scanner unit (document reading unit) 31, a CPU 32, a recording unit 33, an operation panel unit 34, a network interface unit 35, a printer unit 36, and a temporary memory unit 37.

The scanner unit 31 serves to read a document that is placed on a document table (not shown in Figure) and outputs image data.

The CPU 32 serves to control the overall MFP 1, and functionally comprises a received data analysis unit 321 and an image controller unit 322.

The received data analysis unit 321 analyzes data that is received via the network interface unit 35. If the received data is facsimile data or print data, the image controller unit 322 performs image conversion processing on the data based on an image processing setting, then it is transmitted to the printer unit 36, and then printed by the printer unit 36. If the received data is data to be stored, it is recorded in the recording unit 33.

In the present embodiment, the received data analysis unit 321 further serves to acquire and analyze document data to be merged, which is specified by a user among document data accumulated in a shared folder in the PC 2, and acquire attributes from the document data. The attributes include file format, resolution, size, full-color/monochrome, etc.

The image controller unit 322 performs a predetermined image process on image data of the document read by the scanner unit 31, and then transmits it to the printer unit 36 to make it printed or transmits via the network interface unit 35 to a destination set by the operation panel unit 34. There are various methods available for the transmission: e-mail, SMB transmission, FTP transmission, facsimile transmission, etc.

In the present embodiment, the image controller unit 322 further sets a reading mode of the scanner 31 and converts image data readout from a document, when the document is read by the scanner 31, in order to merge the image data with document data to be merged (to be described below).

In addition, the image controller unit 322 serves to judge whether or not the document data to be merged, which is acquired by the received data analysis unit 321, is data that is able to be merged with the image data read out by the scanner unit 31, based on attributes of the document data. If the document data is not data that is able to be merged, it also converts it to data that is able to be merged.

The recording unit 33 records various data in itself, and comprises a hard disk drive (HDD) for example.

The operation panel unit 34 has a display unit 341 that comprises a key operation unit and a liquid crystal display panel, etc., and it serves to set a document reading condition of the scanner 31 and a destination, specify document data with which image data of a document read by the scanner 31 to merge, and specify to which location (page) of the document data to attach the image data if the document data contains a plurality of pages.

The network interface unit 35 serves as a communication unit to exchange data with the PCs 2 and others via the network 3.

The printer unit 36 prints image data, and said temporary memory 37 temporarily records in itself image data read out by the scanner unit 31, data transmitted from an external device, etc.

Hereinafter, one embodiment of user operations to merge image data of a document read by the scanner 31 with document data recorded in a shared folder in the PC 2, and replace the original document data with the merged data, will be described.

There is in a shared folder in the PC 2, document data (with the attributes of file name: aaa.jpeg, file format: JPEG, resolution: 400 dpi×600 dpi, size: A3, and color information: monochrome).

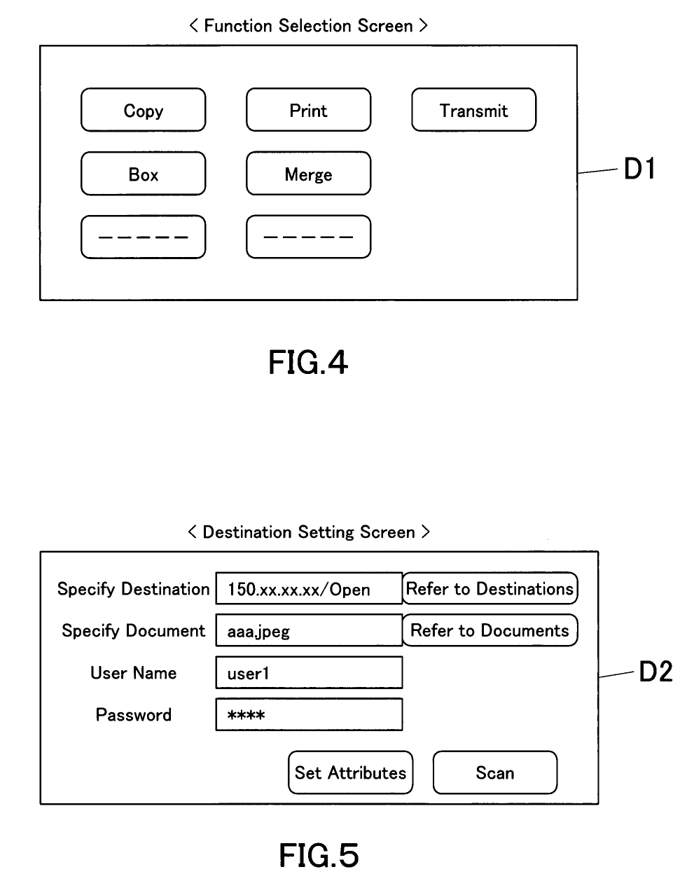

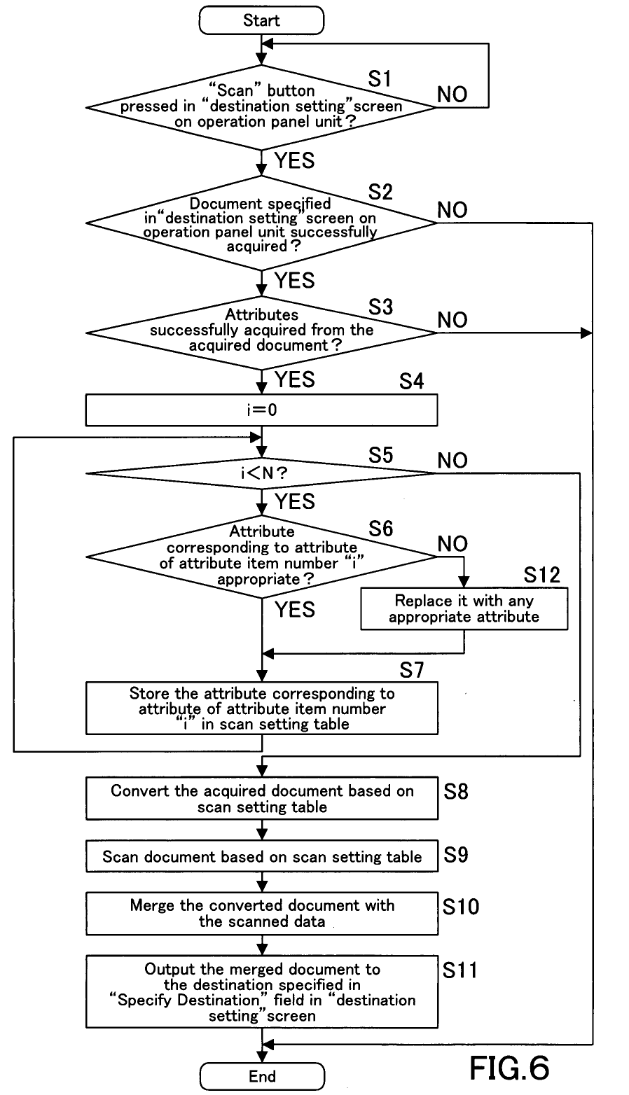

A user places a document on a document table of the MFP 1, and selects a “merge” button in a function selection screen D1 shown in FIG. 4, which is displayed on the display unit 341 of the operation panel unit 34. Then, the screen is switched to a destination setting screen D2 shown in FIG. 5.

In the destination setting screen D2, the user specifies the PC 2 by its IP address (150.xx.xx.xx) as a destination, document data (aaa.jpeg) in the shared folder (Open) as document data to be merged, and user information (a user name and a password) to log in the PC 2. And finally, the user presses a “scan” button.

FIG. 6 is a flowchart showing the data merger/replacement process to be executed by the CPU 32 in the MFP 1 when the “scan” button is pressed. The process is executed by the CPU32 according to a program recorded in the ROM (not shown in Figure) or the recording unit 33.

In FIG. 6, it is determined in Step S1 whether or not the “scan” button is pressed in the destination setting screen D2 displayed on the display unit 341 of the operation panel unit 34. If the “scan” button is not pressed (NO in Step S1), the routine waits until it is pressed, and if the “scan” button is pressed (YES in Step S1), the routine proceeds to Step S2.

In Step S2, it is determined whether or not the destination specified in the destination setting screen D2 displayed on the display unit 341 of the operation panel unit 34, in other words, the document data in the shared folder in the PC 2 ( [symbol] 150.xx.xx.xx [symbol] Open [symbol] aaa.jpeg), is acquired. If the specified document data is not acquired (NO in Step S2), the routine directly terminates. If the specified document data is acquired (YES in Step S2), the routine proceeds to Step S3.

In Step S3, it is determined whether or not the attributes (file format: JPEG, resolution: 400 dpi×600 dpi, size: A3, and color information: monochrome) is acquired from the acquired document data (aaa.jpeg). If the attributes of the document data are not acquired (NO in Step S3), the routine directly terminates. If the attributes of the document data are acquired (YES in Step S3), the routine proceeds to Step S4.

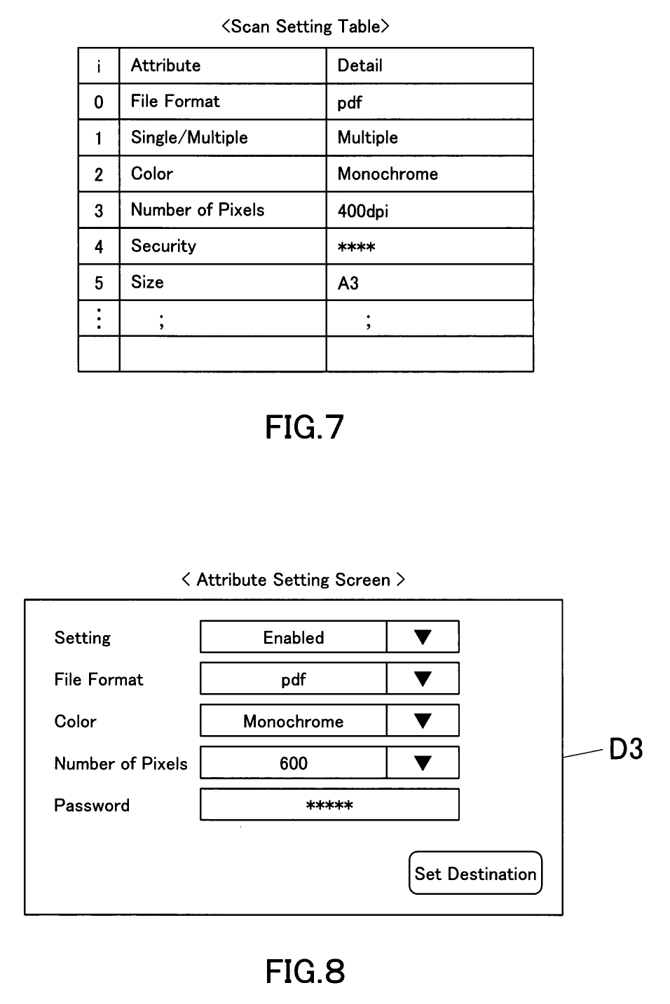

In Step S4, number of attribute items (i=0, 1, 2 . . . N) in a scan setting table shown in FIG. 7 are started to be counted in advance to determine whether or not the acquired document data is data that is able to be merged. Then in Step S5, it is determined whether or not i<N, and if i<N (YES in Step S5), the routine proceeds to Step S6.

In Step S6, it is determined whether or not the attribute of the document data, which corresponds to an attribute of the attribute item number “i”, is appropriate as an attribute of data to be merged, which is able to be merged with image data. If it is appropriate (YES in Step S6), then in Step S7, the attribute of the document data is stored as an attribute of the attribute item number “i” in the scan setting table shown in FIG. 7, and then the routine goes back to Step S5. If the attribute of the document data, which corresponds to an attribute of the attribute item number “i” is not appropriate (NO in Step S6), then in Step S12, the attribute is replaced with another attribute that is appropriate for merger, and then the routine proceeds to Step S7.

A condition to determine whether or not it is appropriate as an attribute of data to be merged, is preliminarily set on the MFP1. An attribute that is not appropriate will be described below.

For instance, the document data (aaa.jpeg) with a JPEG file format is acquired here. Since JPEG data is not able to include multiple pages, the MFP 1 automatically determines it is not appropriate as an attribute of data to be merged, and stores a file format that is appropriate for merger (PDF is set herein), not JPEG, as an “file format” attribute in the scan setting table.

Thus, it is checked whether or not the attributes of the document data are appropriate, one by one about the respective attribute items in the scan setting table.

If checking about every item is completed (No in Step S5), the routine proceeds to Step S8.

In Step S8, the acquired document data (aaa.jpeg) is converted to data having an attribute predetermined in the scan setting table. In the present embodiment, it is converted to a PDF format of document data (aaa.pdf). In Step S9, a document is read (scanned) by the scanner unit 31 by a document reading mode that is set to bring data with an attribute predetermined in the scan setting table, and then in Step S10, the converted document data (aaa.pdf) and the readout image data are merged.

Subsequently, in Step S11, the merged data is outputted according to the information specified in the destination setting screen D2, to the shared folder ( [symbol] 150.xx.xx.xx [symbol] Open) in the PC 2, in which the original document data (aaa.pdf) exists, and the original document is replaced with the merged data. Then, the routine terminates.

In this way, by simple user operation to specify document data to be merged and give an instruction to read a document by the scanner unit 31, not only image data read out from a document can be automatically merged with specified document data but also the original document can be automatically replaced with the merged data without user intervention to use dedicated application software or give an instruction for replacement.

Further, it is judged based on attributes of the document data whether or not the document data is data that is able to be merged. If it is judged the document data is not data that is able to be merged, the specified document data can be converted to data that is able to be merged, and image data that is able to be merged can be acquired by the scanner unit 31. Thus, merger of two pieces of data can be successfully performed, so as originally intended.

Hereinafter, another embodiment of user operations to merge image data of a document read by the scanner unit 31 and document data recorded in a shared folder in the PC 2, and replace the original document data with the merged data, will be explained. In the present embodiment, a user arbitrarily can specify attributes of document data to be merged, and also attributes of image data of a document read by the scanner unit 31, which is to be merged with the document data.

There is in a shared folder in the PC 2, document data (with the attributes of file name: aaa.jpeg, file format: JPEG, resolution: 400 dpi×600 dpi, size: A3, and color information: monochrome).

A user places a document on a document table of the MFP 1, and selects a “merge” button in the function selection screen D1 shown in FIG. 4, which is displayed on the display unit 341 of the operation panel unit 34. Then the screen is switched to the destination setting screen D2 shown in FIG. 5.

In the destination setting screen D2, the user specifies the PC 2 by its IP address (150.xx.xx.xx) as a destination, document data (aaa.jpeg) in a shared folder (Open) as document data to be merged, and user information (a user name and a password) to log in the PC 2. And finally, the user presses a “set attributes” button.

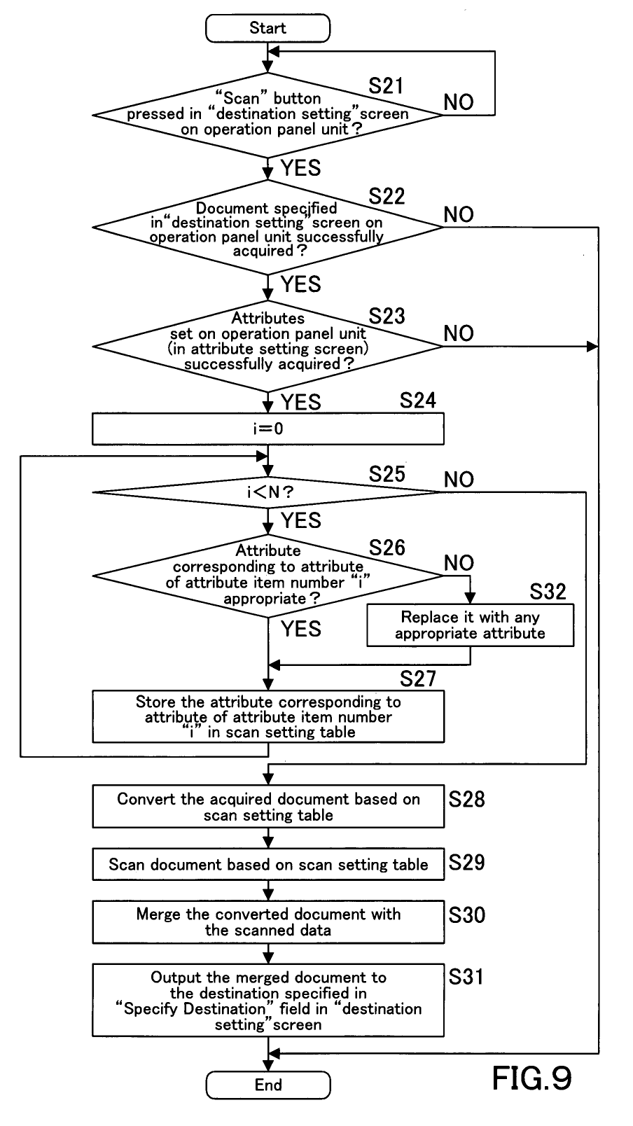

Then, the screen is switched to an attribute setting screen D3 shown in FIG. 8, in which the user can set attributes. In the present embodiment, the user can make inputs about the respective attribute items: attribute setting enabled/disabled, file format, color, number of pixels and password. A password is inputted to ensure the merged data.

If the user presses a “set destination” button after the attribute setting, the screen is back to the destination setting screen D2 shown in FIG. 5, in which the user presses the “scan” button.

FIG. 9 is a flowchart showing a data merger/replacement process to be executed by the CPU 32 in the MFP 1, when a “scan” button is pressed. The process is executed by the CPU 32 according to a program recorded in the ROM (not shown in Figure) or the recording unit 33.

In FIG. 9, it is determined in Step S21 whether or not the “scan” button is pressed in the destination setting screen D2 displayed on the display unit 341 of the operation panel unit 34. If the “scan” button is not pressed (NO in Step S21), the routine waits until it is pressed. If the “scan” button is pressed (YES in Step S21), the routine proceeds to Step S22.

In Step S22, it is determined whether or not the destination specified in the destination setting screen D2 displayed on the display unit 341 of the operation panel unit 34, in other words, the document data in the shared folder in the PC 2 ( [symbol] 150.xx.xx.xx [symbol] Open [symbol] aaa.jpeg), is acquired. If the specified document data is not acquired (NO in Step S22), the routine directly terminates. If the specified document data is acquired (YES in Step S22), the routine proceeds to Step S23.

In Step S23, if the attribute setting is “enabled” in the attribute setting screen D3 shown in FIG. 8, it is then determined whether or not the attributes (file format, color, number of pixels, etc.) set on the operation panel unit 3 are acquired. If the set attributes are acquired (YES in Step S23), the routine proceeds to Step S24. If the set attributes are not acquired, or if the attribute setting is not “enabled” in the attribute setting screen D3 (NO in Step S23), the routine directly terminates.

In Step S24, number of attribute items (i=0, 1, 2 . . . N) in the scan setting table shown in FIG. 7 are started to be counted in advance to determined whether or not the acquired attributes are appropriate for merger of two pieces of data. Then it is determined in Step S25 whether or not i<N, and if i<N (YES in Step S25), the routine proceeds to Step S26.

In Step S26, it is determined whether or not the set attribute corresponding to an attribute of the attribute item number “i” is appropriate. If it is appropriate (YES in Step S26), then in Step S27, the set attribute is stored as an attribute of the attribute item number “i” in the scan setting table shown in FIG. 7, and the routine goes back to Step S25. If it is not appropriate (NO in Step S26), the in Step S32, the attribute of the attribute item number “i” is replaced with an appropriate attribute that is other than the set attribute, and then the routine proceeds to Step S27.

Thus, it is checked whether or not the set attributes are appropriate, one by one about the respective attribute items in the scan setting table.

If checking about every item is completed (NO in Step S25), the routine proceeds to Step S28.

In Step S28, the acquired document data (aaa.jpeg) is converted to data having a predetermined attribute in the scan setting table. In this embodiment, it is converted to a PDF format of document data (aaa.pdf). In Step S29, a document is read (scanned) by the scanner unit 31 by a document reading mode that is set to bring data with a predetermined attribute in the scan setting table, and then in Step S30, the converted document data (aaa.pdf) and the readout image data are merged.

Subsequently, in Step S11, the merged data is outputted according to the information specified in the destination setting screen D2, to the shared folder ( [symbol] 150.xx.xx.xx [symbol] Open) in the PC 2, in which the original document data (aaa.pdf) exists, and the original document is replaced with the merged data. Then, the routine terminates.

In this way, in the embodiment shown in FIG. 9, since a user arbitrarily can specify attributes of data to be merged, document data to be merged and image data read out by the scanner unit 31 are merged into data having the attributes preferred by the user.

Hereinafter, one embodiment in which document data to be merged includes a plurality of pages, and a user specify a location of the document data where to attach image data, then the image data is attached to the specified location, and then the original document data is replaced with the merged data, will be explained.

There is in a shared folder in the PC 2, document data including a plurality of pages (with the attributes of file name: aaa.jpeg, file format: JPEG, resolution: 400 dpi×600 dpi, size: A3, and color information: monochrome).

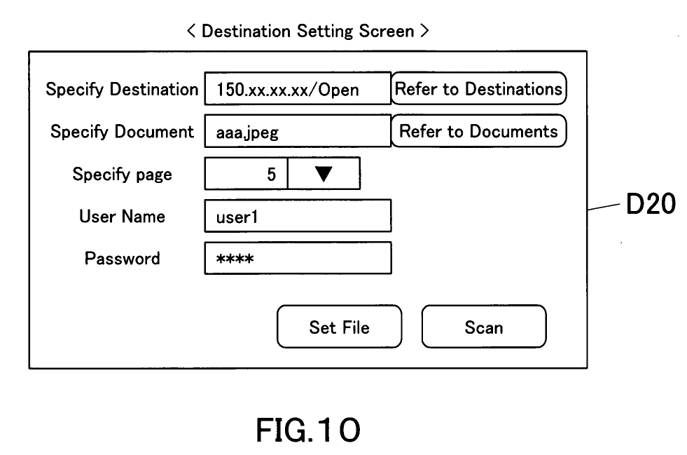

A user places a document on a document table of the MFP 1, and selects a “merge” button in the function selection screen D1 shown in FIG. 4, which is displayed on the display unit 341 of the operation panel unit 34. Then the screen is switched to a destination setting screen D20 shown in FIG. 10.

In the destination setting screen D20, the user specifies the PC 2 by its IP address (150.xx.xx.xx) as a destination, document data (aaa.jpeg) in a shared folder (Open) as document data to be merged, and a page that is a location where to be attached. In an example shown in FIG. 10, the page 5 of the document data is specified as the location. Then, the user specifies user information (a user name and a password) to log in the PC 2, and finally, the user presses a “scan” button.

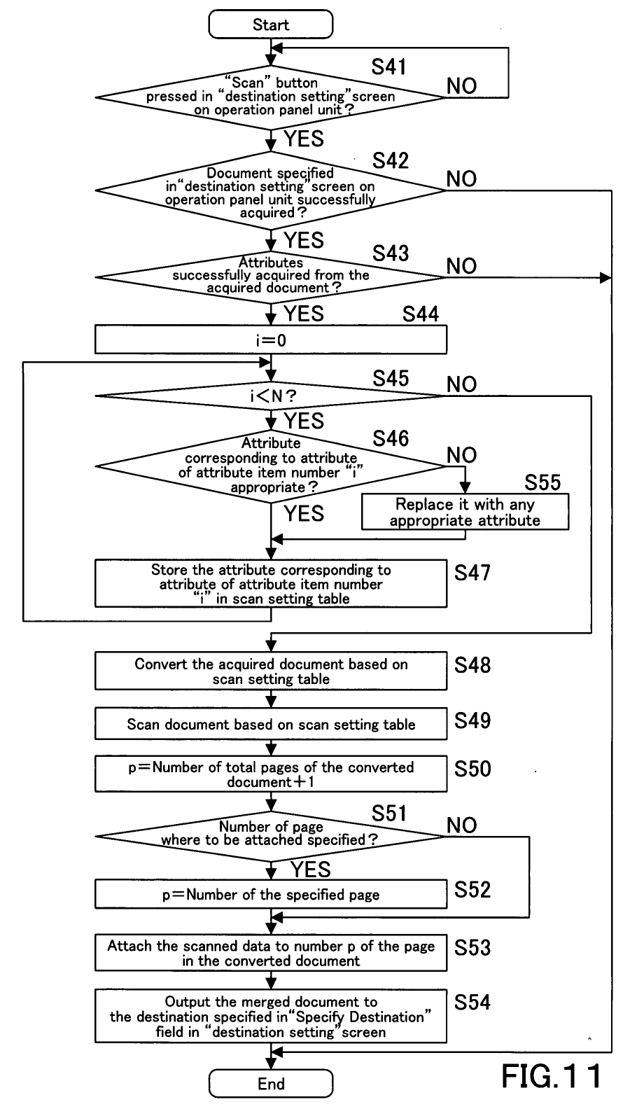

FIG. 11 is a flowchart showing a data merger/replacement process to be executed by the CPU 32 in the MFP 1, when a “scan” button is pressed. The process is executed by the CPU 32 according to a program recorded in the ROM (not shown in Figure) or the recording unit 33.

An explanation about the process from Steps S41 to S48 and S55 in FIG. 11 will be omitted, since it is the same as the process from Steps S1 to S8 and S12 in FIG. 6, and the process after Step S48 will be mainly explained.

In Step S48, the acquired document data (aaa.jpeg) is converted to data having an attribute predetermined in the scan setting table. In the present embodiment, it is converted to a PDF format of document data (aaa.pdf). In Step S49, a document is read (scanned) by the scanner unit 31 by a document reading mode that is set to bring data with an attribute predetermined in the scan setting table, and then in Step S50, p (number of a page to be specified) is set to “the number of overall pages of the converted document data (aaa.pdf)”+1.

Subsequently, in Step S51, it is determined whether or not number of a page where to be attached is specified. If number of a page where to be attached is specified (YES in Step S51), it is determined in Step S52 that p=number of the specified page, then the routine proceeds to Step S53. If number of a page where to be attached is not specified (NO in Step S51), the routine directly proceeds to Step S53.

In Step S53, merger is performed by attaching image data read by the scanner unit to the number p of the page in the converted document data. Then, in Step S54, the merged data is outputted according to the information specified in the destination setting screen D2, which is the shared folder ( [symbol] 150.xx.xx.xx [symbol] Open) in the PC 2, in which the original document data (aaa.pdf) exists, and the original document is replaced with the merged data. Then, the routine terminates.

In the respective embodiments described so far, image data of a document read out by the scanner unit 31 is merged with specified document data. However, the specified document data can be directly replaced with the image data without merger. Hereinafter, one embodiment of this case will be explained.

There is in a shared folder in the PC 2, document data (with the attributes of file name: aaa.jpeg, file format: JPEG, resolution: 400 dpi×600 dpi, size: A3, and color information: monochrome).

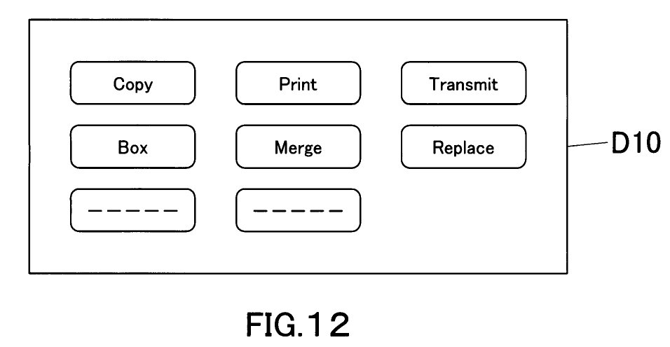

A user places a document on a document table of the MFP 1, and selects a “replace” button in the function selection screen shown in FIG. 12, which is displayed on the display unit 341 of the operation panel unit 34, the screen is switched to the destination setting screen D2 shown in FIG. 5.

In the destination setting screen D2, the user specifies the PC2 by its IP address (150.xx.xx.xx) as a destination, document data (aaa.jpeg) in a shared folder (Open) as document data to be replaced, and user information (a user name and a password) to log in the PC 2. And finally, the user presses a “scan” button.

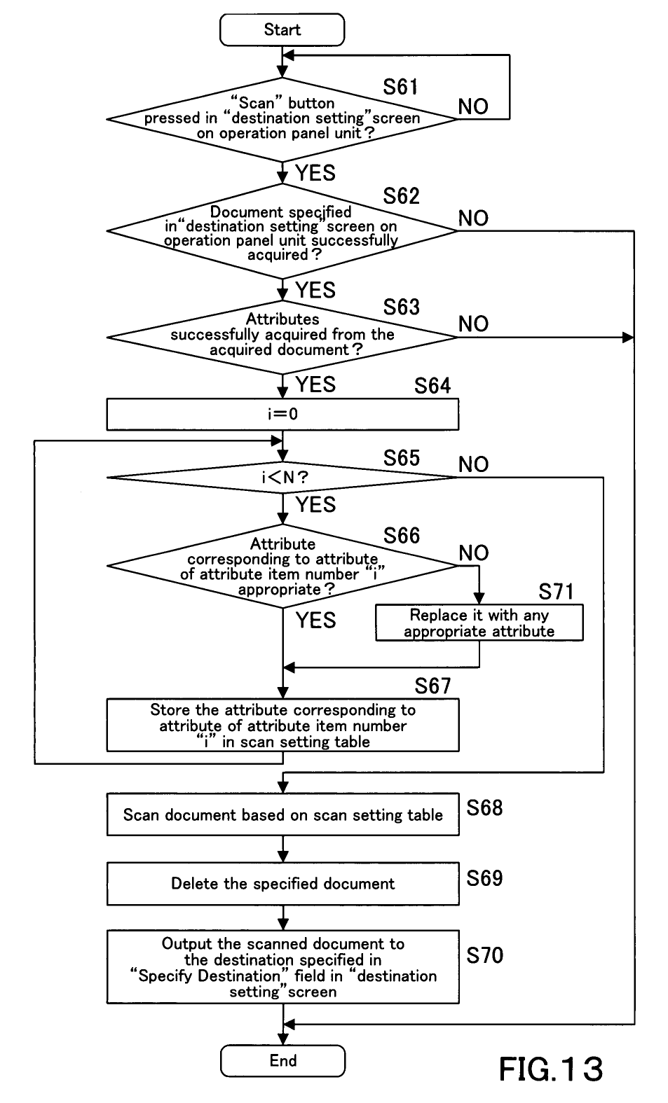

FIG. 13 is a flowchart showing the data merger/replacement process to be executed by the CPU 32 in the MFP 1, when the “scan” button is pressed. The process is executed by the CPU 32 according to a program recorded in the ROM (not shown in Figure) or the recording unit 33.

In FIG. 13, it is determined in Step S61 whether or not a “scan” button is pressed in the destination setting screen D2 displayed on the display unit 341 of the operation panel unit 34. If the “scan” button is not pressed (NO in Step S61), the routine waits until it is pressed. If the “scan” button is pressed (YES in Step S61), the process proceeds to Step S62.

In Step S62, it is determined whether or not the destination specified in the destination setting screen D2 displayed on the display unit 341 of the operation panel unit 34, in other words, the document data ( [symbol] 150.xx.xx.xx [symbol] Open [symbol] aaa.jpeg) in the shared folder in the PC 2, is acquired. If the specified document data is not acquired (NO in Step S62), the routine directly terminates. If the specified document data is acquired (YES in Step S62), the process proceeds to Step S63.

In Step S63, it is determined whether or not the attributes (file format: JPEG, resolution: 400 dpi×600 dpi, size: A3, and color information: monochrome) is acquired from the acquired document data (aaa.jpeg). If the attributes of the document data are not acquired (NO in Step S63), the routine directly terminates. If the attributes of the document data are acquired (YES in Step S63), the routine proceeds to Step S64.

In Step S64, number of attribute items (i=0, 1, 2 . . . N) in the scan setting table shown in FIG. 7 are started to be counted. Then in Step S65, it is determined whether or not i<N, and if i<N (YES in Step S65), the routine proceeds to Step S66.

In Step S66, it is determined whether or not the attribute of the document data, which corresponds to an attribute of the attribute item number “i” is appropriate. If it is appropriate (YES in Step S66), then in Step S7, the attribute of the document data is stored as an attribute of the attribute item number “i” in the scan setting table shown in FIG. 7, and then the routine goes back to Step S65. If the attribute of the document data, which corresponds to an attribute of the attribute item number “i” is not appropriate (NO in Step S66), then in Step S12, the attribute of the attribute item number “i” item is replaced with another attribute that is appropriate, and then the routine proceeds to Step S67.

Thus, it is checked whether or not the attributes of the document data are appropriate, one by one about the respective attribute items in the scan setting table.

If checking about every item is completed (No in Step S65), the routine proceeds to Step S68.

In Step S68, a document is read (scanned) by the scanner unit 31 by a document reading mode that is set to bring data with an attribute predetermined in the scan setting table. The specified document data is deleted in Step S69, and read out image data is outputted according to the information specified in the destination setting screen D2, to the shared folder ( [symbol] 150.xx.xx.xx) in the PC 2, in which the original document (aaa.pdf) exists. Then, the original document data is replaced with the image data, and then the routine terminates.

In this way, by simple user operation to specify document data to be replaced and read a document by the scanner unit 31, data can be automatically replaced without user invention to give an instruction for replacement.

Those described above are embodiments of the present invention, however, the present invention is not limited to the embodiments. For instance, in the embodiments, it is configured that a reading mode is set on the scanner unit 31 in advance and a document is read by the scanner 31. Meanwhile, it is also configured that the readout image data is converted to data having an appropriate attribute, which is able to be merged with document data to be merged, after the document is read by the scanner unit 31.

In addition, in the embodiments, it is configured that document data in the PC 2 and image data read out by the scanner unit 31 are merged and the original document data is replaced with the merged data, or it is configured that the document data in the PC 2 is deleted and replaced with the image data, by the MFP 1. Meanwhile, it also can be configured that document data in the PC 2 is specified and image data read out by the scanner unit 31 is transmitted to the PC 2 with instructions for merger and replacement or an instruction for replacement only. In this case, the image controller unit 322 explained in the embodiments is used as a control unit to give an instruction for merger or replacement, and does not necessarily have a function to merge or replace document data by itself. Therefore, it is the PC 2 that receives the instruction, to control the process to merge and replace document data with image data, or to replace the document data with the image data.

In addition, document data to be merged or replaced does not necessarily exist in the PC 2 that is outside of the MFP 1, and may exist inside of the MFP 1.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus, comprising:
a document data specification unit to specify document data to be merged, among document data accumulated in an accumulation unit;
a scanner unit to read a document; and
a control unit to merge image data of the document read by said scanner unit with said specified document data and then replace the original document data with the merged data, or alternatively, to give instructions for the merger and the replacement.

2. The image processing apparatus as recited in claim 1, further comprising:
an attribute acquisition unit to acquire attributes of said specified document data; and
a conversion unit to determine based on the acquired attributes whether or not the specified document data is data that is able to be merged, and then convert the specified document data into the data that is able to be merged if it is judged not able to be merged.

3. The image processing apparatus as recited in claim 1, further comprising a mode setting unit to set a reading mode of said scanner unit, in order to make the image data of the document read by said scanner unit, data that is able to be merged with said specified document data.

4. The image processing apparatus as recited in claim 1, further comprising a conversion unit to convert the image data of the document read by said scanner unit, into data that is able to be merged with said specified document data.

5. The image processing apparatus as recited in claim 1, further comprising a merger location specification unit to specify a location in the document data where to attach said image data, wherein:
said document data includes a plurality of pages; and
said control unit attaches said image data to the location in the document data, which is specified by said merge location specification unit, or alternatively, gives an instruction for the merger.

6. An image processing apparatus, comprising:
a document data specification unit to specify document data to be replaced, among document data accumulated in an accumulation unit;
a scanner unit to read a document; and
a control unit to control a process to replace said specified document data with image data read out by said scanner unit, or alternatively, to give an instruction for the replacement.

7. An image processing method that is used in an image processing apparatus, and the image processing method comprises:
specifying document data to be merged, among document data accumulated in an accumulation unit;
reading a document by a scanner unit; and
controlling a process to merge image data of the document read by said scanner unit with said specified document data and then replace the original document data with the merged data, or alternatively, give instructions for the merger and the replacement.

8. The image processing method as recited in claim 7, further comprising:
acquiring attributes of said specified document data; and
determining based on the obtained attributes whether or not the specified document data is data that is able to be merged, and then converting the specified document data into the data that is able to be merged if it is determined not able to be merged.

9. The image processing method as recited in claim 7, further comprising the step of setting a reading mode of said scanner unit, in order to make the image data of the document read in said reading step, data that is able to be merged with said specified document data.

10. The image processing method as recited in claim 7, further comprising the step of converting the image data of the document read by said scanner unit, into data that is able to be merged with said specified document data.

11. The image processing method as recited in claim 7, further comprising the step of specifying a location in the document data where to attach said image data, wherein:
said document data includes a plurality of pages; and
said image data is attached to said specified location in the document data, or alternatively, an instruction for merger is given, in said control step.

12. An image processing method to be performed by an image processing apparatus, comprising:
specifying document data to be replaced, among document data accumulated in an accumulation unit;
reading a document by a scanner unit; and
replacing said specified document data with image data of the document read by said scanner unit, or alternatively, giving an instruction for the replacement.

13. A recording medium, having a recorded image processing program to make a computer in an image processing apparatus execute:
specifying document data to be merged, among document data accumulated in an accumulation unit;
reading a document by a scanner unit; and
merging image data of the document read by said scanner unit with said specified document data and then replacing the original document data with the merged data, or alternatively, giving instructions for the merger and the replacement.

14. The recording medium as recited in claim 13, having said recorded image processing program to make a computer further execute:
acquiring attributes of said specified document data; and
determining based on the acquired attributes whether or not the specified document data is data that is able to be merged, and then converting the specified document data into the data that is able to be merged if it is determined not able to be merged.

15. The recording medium as recited in claim 13, having said recorded image processing program to make a computer further execute:
setting a reading mode of said scanner unit, in order to make the image data of the document read in said reading step, data that is able to be merged with said specified document data.

16. The recording medium as recited in claim 13, having said recorded image processing program to make a computer further execute:
converting the image data of the document read by said scanner unit, into data that is able to be merged with said specified document data.

17. The recording medium as recited in claim 13, having said recorded image processing program to make a computer further execute the step of specifying a location in the document data where to merge said image data, wherein:
said document data includes a plurality of pages; and
said image data is attached to said specified location in the document data, or alternatively, an instruction for merger is given.

18. A recording medium, having a recorded image processing program to make a computer in an image processing apparatus execute:
specifying document data to be replaced, among document data accumulated in an accumulation unit;
reading a document by a scanner unit; and
replacing said specified document data with the image data of the document read by said scanner unit, or alternatively, giving an instruction for the replacement.
